(19) United States
(12) Patent Application Publication
(10) Pub. No.: US 2026/0010853 A1
(43) Pub. Date: Jan. 8, 2026

(54) IMPACT PROPAGATION IN IT SYSTEMS

(71) Applicant: E.S.I. SOFTWARE LTD, Givath Shmuel (IL)

(72) Inventors: Mojca KOMAVEC OSOJNIK, Borovnica (SI); Bostjan KALUZA, Ljubljana (SI); Eyal OZ, Petah Tikva (IL); Alexander Sasha GILENSON, Givatayim (IL)

(21) Appl. No.: 18/764,195

(22) Filed: Jul. 4, 2024

(51) Int. Cl. G06Q 10/0635

(52) U.S. Cl. CPC G06Q 10/0635

(57) ABSTRACT

A method of evaluating impact of a change on nodes of a network, including collecting information of changes to configuration items of the network with a change management module that is executed on a computer of the network and forming a list of changes, receiving a dependency graph that defines dependencies between nodes of the network, receiving an impact model that includes an impact value that provides an indication of a risk value for different types of changes to nodes of the dependencies, executing an impact score generation module configured to receive the dependency graph, the impact model and the list of changes to determine a risk value responsive to a specific change to a node of the network and an impact of the change on other nodes of the network, repairing or predicting problems in the network based on the determined risk value for each change.

### FIELD OF THE DISCLOSURE

The present disclosure relates to a system and method of evaluating the impact of changes on elements of an IT environment.

### BACKGROUND OF THE DISCLOSURE

Nowadays information technology (IT) environments generally consist of a large number of servers and associated components that are connected over a network. Servers can be managed on-premise, on cloud or as a combination of both. Since they are hosting important business applications, monitoring and managing such IT environments is crucial. These applications should be reliable, responsive in order to deliver services according to a specific Service Level Agreement (SLA). To enforce SLA and mitigate problems and incidents that arise in IT environments, companies are using different processes, such as change management and problem management.

Change management defines planning, scheduling, implementation, and evaluation of changes in complex IT environments. Even though the companies can meticulously follow the change management process, problems stemming from applied changes can occur. An approach for analyzing and prioritizing changes is described in the U.S. Pat. No. 9,524,465 to Gilenson et al (Dec. 20, 2016) and it will be used as a reference for collecting the analysis of detected changes.

Problem management defines problem detection, categorization, prioritization, diagnosis, root cause analysis, resolution, evaluation and proactive remediation. In order to be efficient in problem management, one has to have a deep understanding of the IT environment, their components and their dependencies. Dependencies can be used in order to determine how a change in one configuration parameter in one component can propagate through the IT environment and affect the behavior of another component. One approach to determine component dependencies that analyzes configuration data is described in the U.S. Pat. No. 10,439,876 to Kaluza et al (Oct. 8, 2019).

Thus it is desirable to be able to construct a system implementing a method of determining an impact of a change in an IT environment. In other words, to uncover how the impact of changes propagate in the IT environment, for example providing a risk score for the impact of the change on affected nodes of the IT environment.

### SUMMARY OF THE DISCLOSURE

An aspect of an embodiment of the disclosure, relates to a system and method for determining a level of influence of a change to nodes in an IT network. Combining change detection with impact propagation uncovers how the impact of a change propagates in the IT network through the dependencies between different components. This information can be used to assess the risk of a change, help with root cause analysis, change planning and assessing impact, blast radius or as a visualization tool. Based on this information the system identifies candidate elements to be repaired or reinstalled when problems occur in the IT network.

There is thus provided according to an embodiment of the disclosure, a method of evaluating impact of a change on nodes of a network, comprising:
collecting information of changes to configuration items of the network with a change management module that is executed on a computer of the network and forming a list of changes;
receiving a dependency graph that defines dependencies between nodes of the network,
receiving an impact model that includes an impact value that provides an indication of a risk value for different types of changes to nodes of the dependencies;
executing an impact score generation module configured to receive the dependency graph, the impact model and the list of changes to determine a risk value responsive to a specific change to a node of the network and an impact of the change on other nodes of the network;
repairing or predicting problems in the network based on the determined risk value for each change.

In an embodiment of the disclosure, the dependency graph represents the nodes of the network as nodes of the graph and the dependencies between the nodes of the network as directional edges connecting between the nodes of the graph. Optionally, each entry of the impact model comprises: a source asset type, a destination asset type, a dependency type between the source asset type and the destination asset type, a change operation type, an impact category and an impact value. In an embodiment of the disclosure, the impact score generation module annotates the edges in the dependency graph with impact values from the impact model. Optionally, the impact score generation module identifies and generates a propagation tree that includes a changed node and nodes that are impacted by the changed node. In an embodiment of the disclosure, the impact score generation module generates propagation risks for the edges of the propagation tree; wherein the propagation risks are generated as a function of the impact values of the edges. Optionally, the impact score generation module merges propagation trees to form a combined propagation risk for the edges. In an embodiment of the disclosure, the impact score generation module generates a propagation risk for the nodes of the propagation tree as a function of the combined propagation risk of the edges; wherein the propagation risk of the root node of the tree serves as the determined risk value. Optionally, the dependency types include: “attached to”, “contained in”, “contains”, “impacts”, “depends on” and “associated with”. In an embodiment of the disclosure, the impact categories include: “performance”, “availability”, “security”, “end user”, “capacity”, “financial”, “scalability”, “compliance”, and “integration”.

There is further provided according to an embodiment of the disclosure, a computer system for evaluating the impact of a change on nodes of a network, comprising:

### One or More Computers Comprising:

A change management module that is configured to collect information of changes to configuration items of the network and forms a list of changes;
An impact score generation module configured to receive a dependency graph that defines dependencies between nodes of the network, a list of changes, an impact model that includes an impact value to provide an indication of a risk value for different types of changes to nodes of the dependencies;
Wherein the impact score generation module is configured to determine a risk value responsive to a specific change to a node of the network and an impact of the change on other nodes of the network;
repairing or predicting problems in the network based on the determined risk value for each change.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a computerized system for evaluating change impact, according to an embodiment of the disclosure;

FIG. 2 is a schematic illustration of a method of determining change impact, according to an embodiment of the disclosure;

FIG. 3 is an exemplary table of an impact model, according to an embodiment of the disclosure;

FIG. 4 is an exemplary illustration of an output of an impact score generation module, according to an embodiment of the disclosure;

FIG. 5 is an exemplary representation of asset dependencies, according to an embodiment of the disclosure;

FIG. 6 is an exemplary dependency graph from asset dependencies, according to an embodiment of the disclosure;

FIG. 7 is an exemplary dependency graph annotated by impact, according to an embodiment of the disclosure;

FIG. 8 is an exemplary propagation tree for a change according to an embodiment of the disclosure;

FIG. 9 is an exemplary tree for generating propagation risk of edges, according to an embodiment of the disclosure;

FIG. 10 is an exemplary tree for generating propagation risk of nodes, according to an embodiment of the disclosure;

FIG. 11 is an exemplary list of dependency types for an Amazon Web Service environment, according to an embodiment of the disclosure; And

FIG. 12 is an exemplary list of concrete examples on an impact model, according to an embodiment of the disclosure.

### DETAILED DESCRIPTION

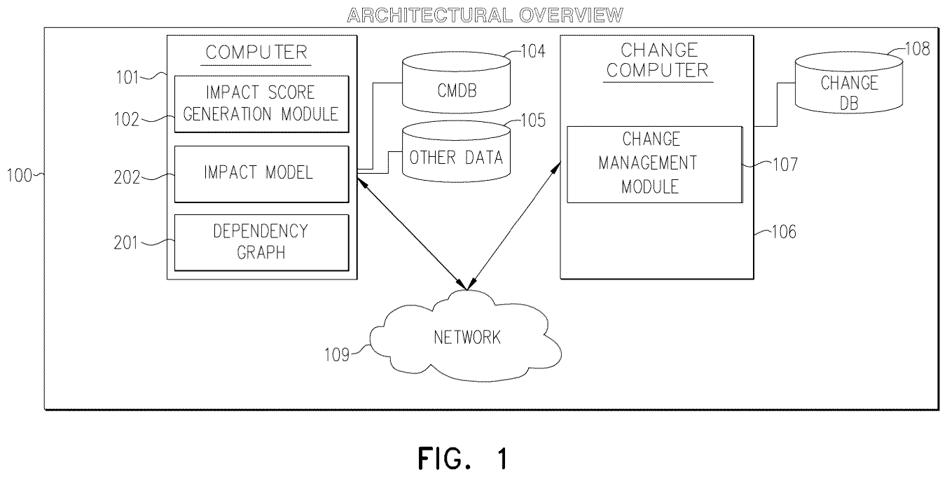

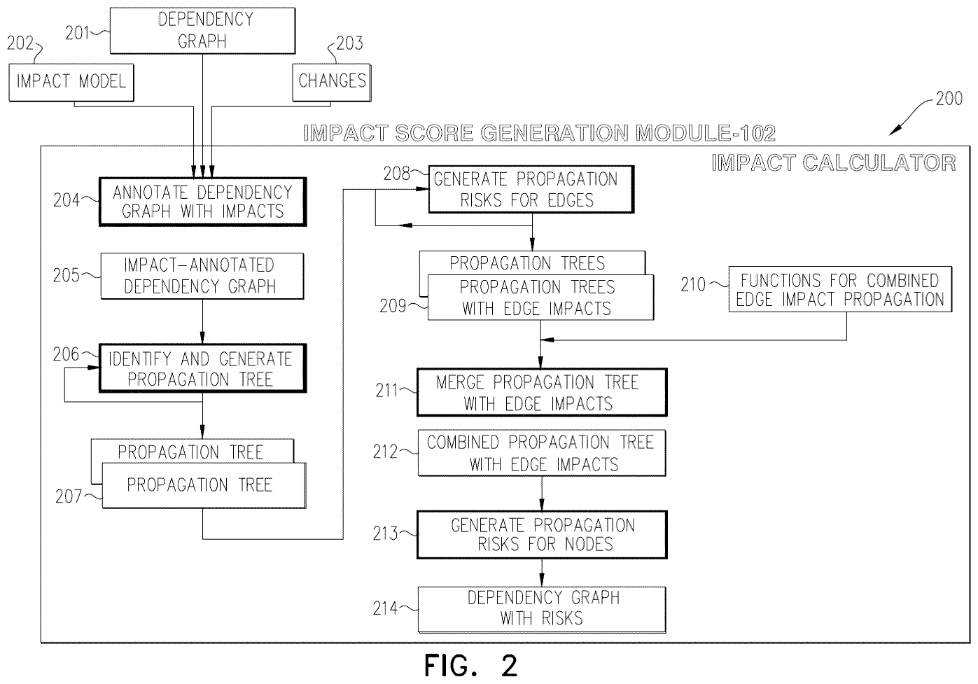

FIG. 1 is a schematic illustration of a computerized system 100 for evaluating change impact, according to an embodiment of the disclosure. In an embodiment of the disclosure, the computerized system 100 includes a change computer 106 for collecting and storing changes in an IT network 109, for example changes in hardware/software and/or changes to configuration parameters. Change computer 106 comprises a change management module 107 to collect the changes and is connected to a database 108 to store a list of the collected changes. Optionally, an impact computer 101 is provided to analyze the changes and determine an impact score for the changes on various nodes of the IT network 109. The impact computer 101 comprises an impact model 202, which generates data for use by an impact score generation module 102 that performs a method 200 (see FIG. 2) to generate a risk value that takes into account the effect of a change on a node and nodes that depend from the changed node. Optionally, the impact computer 101 and the change computer 106 are connected to communicate directly or communicate over the IT network 109.

In some embodiments of the disclosure, the impact score generation module 102 may also receive data from a Configuration Management Database (CMDB) 104 that provides information relating to the elements (software and hardware) of the network 109 and/or other data from a general database 105 for generating the change impact score. Optionally, the change computer 106 and the impact computer 101 may be combined on a single general purpose computer or they may be split into multiple computers collaborating together to evaluate change impact.

In an embodiment of the disclosure, the changes to configuration parameters include details such as which operating systems are used by each node/station, which type of hardware is used (e.g., computer/devices, network devices, storage devices), which software, database schema, cloud resources and other details.

FIG. 2 is a schematic illustration of a method 200 of determining change impact, according to an embodiment of the disclosure. The input of the method 200 includes a dependency graph 201, the impact model 202 and a list of changes 203.

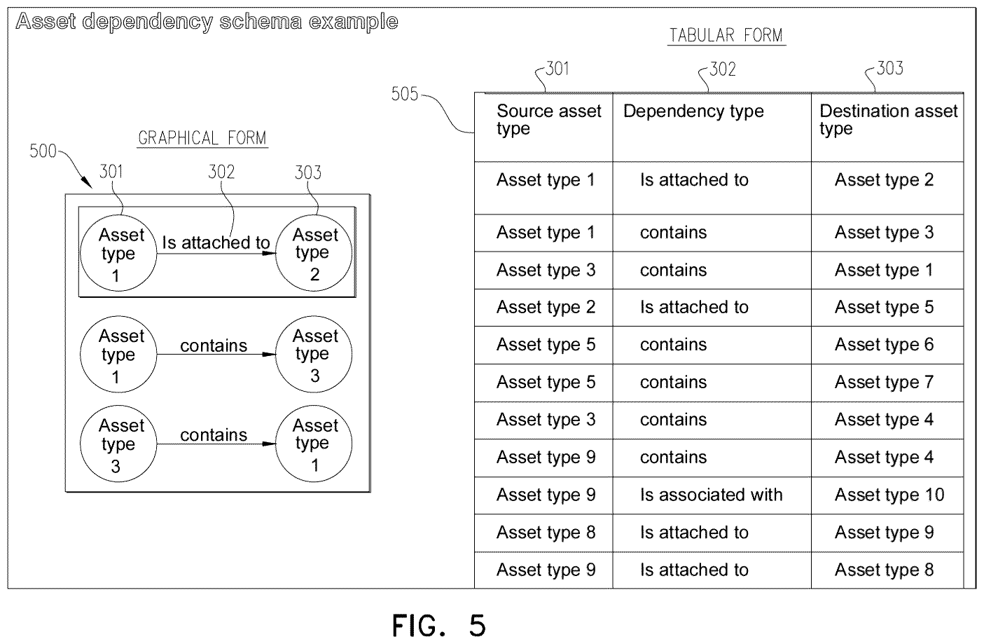

In an embodiment of the disclosure, dependency graph 201 can be constructed in two different ways: (a) by building and populating an asset dependency schema 500 (see e.g., FIG. 5) and building the dependency graph 201 from the asset dependency schema 500 or (b) by importing a manually created dependency graph 201.
a) Asset dependency schema (e.g., 500) or as displayed in tabular form (e.g., 505), is a schema that defines dependencies between different types of assets. An asset can be a resource, configuration item (CI), a component, a host, workstation or other elements. Dependencies are triplet data, containing source asset type 301, dependency type 302, and destination asset type 303.

An asset dependency schema 505 can be created either manually or automatically.
I) Manual creation requires an expert who defines dependencies between different types of assets and rules how to connect them (e.g. which fields of configuration items (CI) in instances of assets should match in order to make a dependency between these two assets). Manual creation should have at least the following fields: source asset type 301, target asset type 303, dependency type 302, rules how to create dependency between source asset type 301 and target asset type 303 (e.g. which fields in the source asset and target asset should match for a dependency) and can be persisted to a permanent media such as file, to a specific application, to CMDB 104 and the like.
II) Automatic creation of an asset dependency schema is based on historical data of logs, discovery tools and the like.
   1) A discovery tool scans configuration files, networks or a combination of both to obtain information about resources in the IT system or network and discover dependencies between the resources based on network load and traffic, configuration item values and the like.
   2) If discovery tools are not used, a machine learning algorithm tries to first uncover resources based on historical data of logs, which include network traffic logs, application logs, infrastructure logs, and system logs. Next, data is cleaned by removing noise and irrelevant information. From the log data, the following features are identified, such as IP addresses, hostnames, resource identifiers, timestamps, event types, log message content and other options. Using clustering algorithms, such as K-means, hierarchical clustering or DBSCAN, enables patterns and groups within the log data to be identified. Each cluster can represent a group of similar log entries, which may correspond to different types of resources. Clusters should be inspected and the algorithm adjusted to see if the resources can be identified.
   3) Machine learning establishes dependencies in the following way. First, it gathers the data from discovery tools about the resources in the IT system or from the previous step. The discovery tools might already have identified some dependencies between the resources. Secondly, it uses historical data, which can include logging information about network traffic, application, infrastructure, and system. Next, the data is cleaned and preprocessed by removing noise, irrelevant information. Relevant features from the data are extracted, such as IP addresses, hostnames, timestamps, service names, communication patterns, network traffic patterns, resource utilization metrics.
   A machine learning algorithm is utilized to analyze the data and to predict whether a dependency between two resources exists or not. Classification machine learning models, such as probabilistic graphical models, graph neural networks, clustering (dependencies can be inferred based on the proximity or similarity of resources within the same cluster) can be used.
III) Once an assets dependency schema 500 is created, it is populated with instances of assets, and can be used to form a dependency graph 201 (e.g., dependency graph 600 as explained below).
b) Another way to obtain a dependency graph 201 is by importing from systems that already have it. Import may come from a database, such as Configuration Management Database (CMDB) 104. Alternatively it can be imported from an Application Performance Monitoring (APM) tool or a discovery tool.

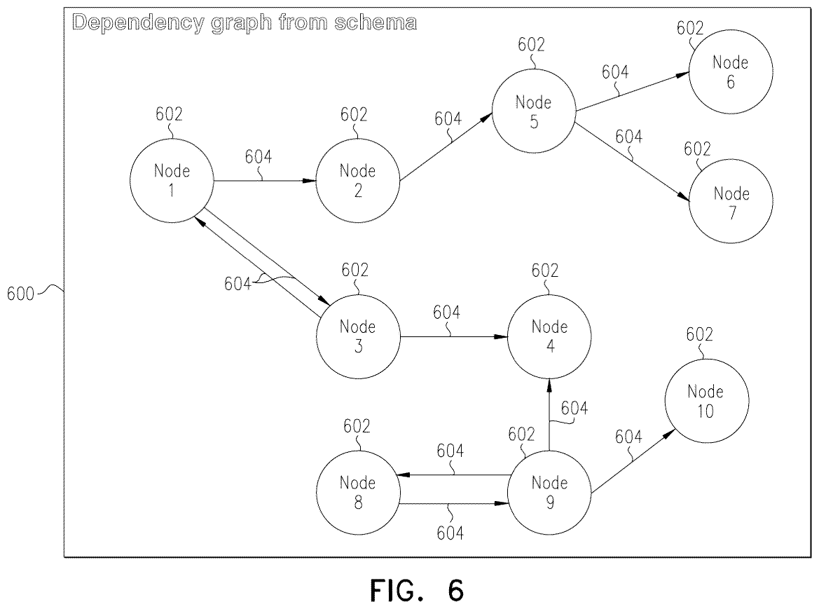

FIG. 6 is a schematic illustration of an exemplary dependency graph 600, according to an embodiment of the disclosure. Dependency graph 600 therefore represents assets with nodes 602 (see FIG. 6) and their dependencies are represented with directed edges 604. Note that dependency, and edge are used interchangeably. Additionally, node, configuration item and asset are also used interchangeably.

Change 203 is an event when a specific configuration parameter's value has changed. For example, by using an agent that periodically scans specified configuration items it is possible to detect such changes. Using this approach, the previous and current value of a change is known as well as some additional data, such as an operation type of a change (add, remove, update).

Change can also be recorded by triggering an alert, since the monitoring state of a specific resource has changed. Additionally, a change can be planned without actually being executed. In this way, we can assess the impact of a future/planned change on an IT environment or a system. In an embodiment of the disclosure, a change is associated with a risk factor, indicating a risk value for various scenarios such as operational risk, compliance risk, and other options. Such information can be used in an impact model 202 instead of or in addition to change operation type 304.

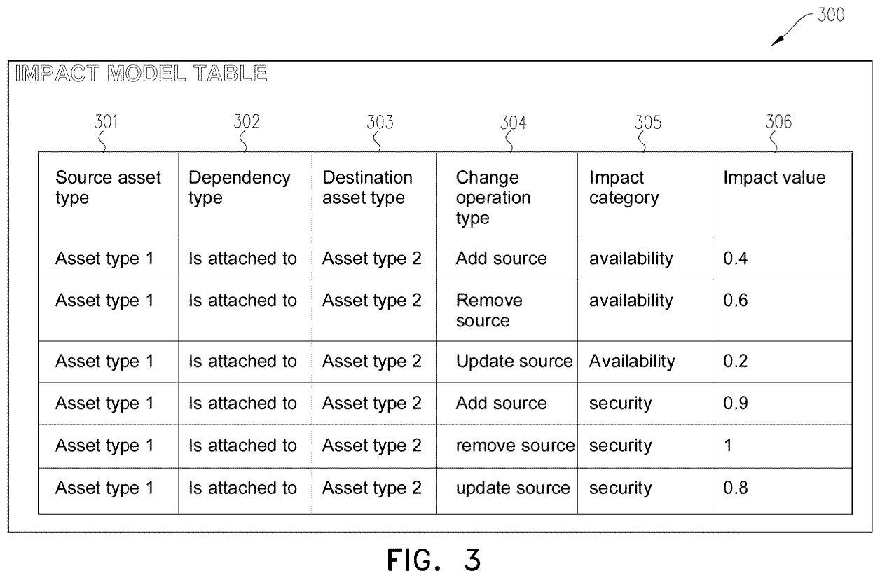

FIG. 3 is an exemplary table 300 of an impact model 202, according to an embodiment of the disclosure. Impact model 202 includes the following data: impact category 305, triplet data for dependency (source asset type 301, dependency type 302, and destination asset type 303), and change properties such as a change operation type 304 with an impact value 306 that indicates a risk value for the change operation type 304 and the given triplet. The impact value 306 can be categorical (e.g. low impact, moderate impact, high impact) or numerical (e.g. representing impact probability in range [0, 1]). In the case of numerical values, higher value could mean higher risk for the specific impact category 305 or specific values may indicate specific types of risk.

Impact categories 305 are based on the use case and can be and are not limited to: performance, availability, security, end user, capacity, financial, scalability, compliance, integration. In an embodiment of the disclosure, the change 203 can provide several values and properties for the impact model 202, such as the change operation type 304 of a change (add source, remove source, update source), previous and current value difference, consistency pattern, compliance with security and regulatory standards, authorization status, value anomaly, and others.

In an embodiment of the disclosure, in impact model 202, the impact values 306 are already generated based on the source asset type 301, dependency type 302, destination asset type 303, change operation types 304, such as add source, remove source, or update source, and different impact categories 305, such as availability and security.

Optionally, the impact values 306 in the impact model can be defined in multiple ways. One way is using an expert, who manually defines impact values 306 for each impact category 305, dependency triplet (301, 302, 303) and change 304. Another way is using historical data to learn about impacts. The historical data can be gathered relating to outages, incidents, disruptions, which include the data of affected resources, duration of the incidents, root causes (changes that caused the issue) and impact on other services.

In an embodiment of the disclosure, the historical data is preprocessed and relevant features are extracted, such as attributes of the affected resources, incident characteristics (e.g. severity, duration), properties of changes made to the environment before the incident, properties of changes identified as root causes, temporal features (such as time of day, day of week, seasonality), potential cascading effect of failures.

Next, impact categories 305 (such as availability, financial losses, end user impact, security, performance, capacity, scalability, compliance, integration) are identified, and the mapping between incident data and impact categories 305 is established. For example an incident “Host is unreachable” corresponds to availability impact and it could also correspond to financial impact since the downtime can result in significant revenue losses, unresponsive application corresponds to the end user impact, not preventing unauthorized access corresponds to a security impact, affecting execution speed corresponds to a performance impact. An alarm “Disk is 95% full” corresponds to capacity impact, slow processing of the load corresponds to scalability impact, enforcing IT policies corresponds to compliance impact, combining different applications to execute business logic corresponds to integration.

In some embodiments of the disclosure, the impact values 306 may be updated responsive to feedback received regarding the accuracy of the generated risk values generated for a change.

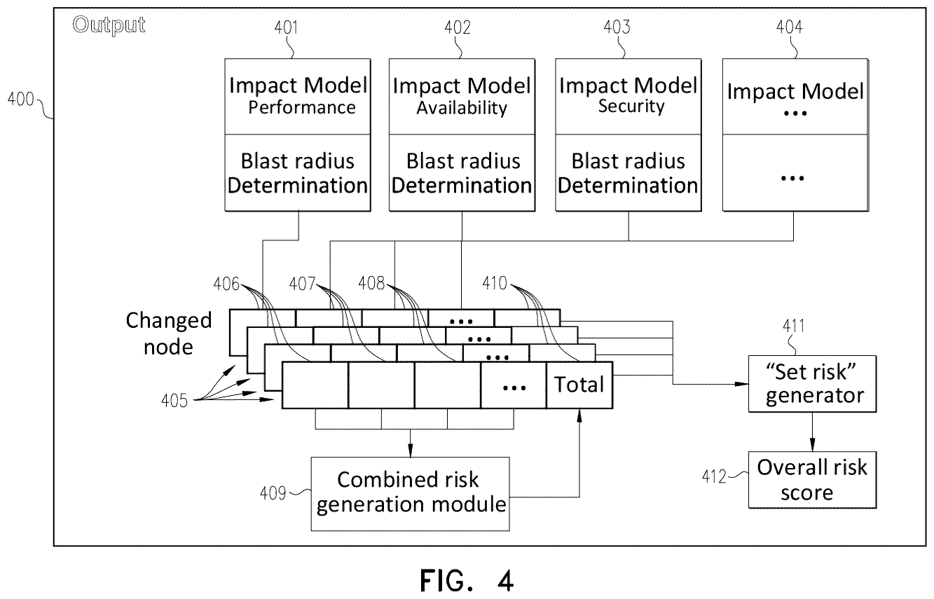

FIG. 4 is an exemplary illustration of output 400 from an impact score generation module 102, according to an embodiment of the disclosure.

Optionally, for each impact category 305, impact value 306 can be determined by a machine learning (ML) model. The ML model generates the probability of selected impact for the dependency between two resources for different change operation types 304 (such as add source, remove source, update source) identified as root causes. ML algorithms for regression can be used, such as logistic regression, decision trees, random forests, gradient boosting machines, neural networks and other methods to generate the score value for the impact.

Once the ML models are trained and validated, the impact score values 306 for dependency triplets (301, 302, 303) for different impact categories 305 and change types 304 are established.

### Impact Score Generation Module 102

Impact score generation module 102 performs method 200 using impact model 202, dependency graph 201, and changes 203 as input.

In an embodiment of the disclosure, the first process (204) of the impact score generation method (200) is to annotate dependency graph 201 with impact values 306 to form an impact annotated dependency graph (e.g., graph 700) from a dependency graph 201 (e.g., graph 600). Initially, the process (204) populates edges 604 in the dependency graph 600 with the corresponding impact values 306 defined in table 300 of the impact model 202. It is possible to define a single impact category 305 on the edges 604 or to store multiple categories on the edges 604. Next, the process identifies on which node nᵢ 702 (or changed node) the change 701 has occurred. The output 205 of this process is an impact-annotated dependency graph (e.g., graph 700).

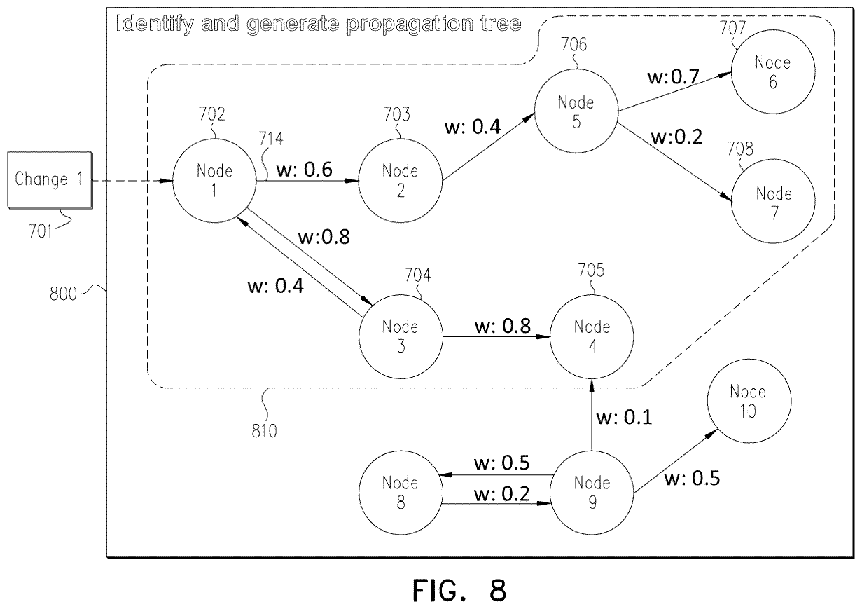

The next process (206) of impact score generation 200 is to identify and generate a “propagation tree” 207 that takes the output 205 of the previous process (e.g., impact-annotated dependency graph 700) with changes 203 as an input. For each change 203 it creates a propagation tree 207 (e.g., propagation tree 810 in FIG. 8) in the following way.

First, it finds and saves all the nodes 602 that the identified node nᵢ can directly impact-“impacted nodes”. This is done recursively for impacted nodes and their impacted nodes until some termination criteria is met, such as reaching leaf nodes, meeting specific edges 604 or specific nodes 602, or reaching a maximum path from the initial node nᵢ. Additionally, the information about the distance (level) from the identified node nᵢ is saved. Each impacted node cannot be visited in multiple levels, therefore loops are resolved. The result is a propagation tree 207 constructed for each change. For example, tree 810 (including nodes 1, 2, 3, 4, 5, 6, 7), which correspond to “change 1” 701 in FIG. 8.

Each propagation tree 207 (or e.g., tree 810) is input into a process (208) “Generate propagation risks for edges”. This process first identifies change parameters (such as operation type 304, previous and current values of a change). For each edge 604 in the propagation tree 207 it generates an impact value 306 (w in FIG. 8). The impact values 306 can be generated for different impact categories 305 and are referred to as edge risks (w) in the propagation tree 207. Optionally, the edge risks (w) may be generated only for a portion of the edges 604 in the propagation tree 207. While traversing a propagation tree 207 and generating the edge risks (w), early termination of generation is possible. This can occur if the generated value is below or above a specific threshold, if the generated value in comparison with some other value has not changed for a specified amount (for example, if edge risks (w) for a previous level and a current level do not change by a specific percent).

There are multiple mechanisms to calculate the edge risk in the propagation tree 207 that can take into account impact model 202, level, and business criticality (explained below). One example of an edge risk calculation is the following. Risk of the edge can be calculated as:

risk_{edge}=impact model(impact category 305,source asset type 301,dependency type 302,destination asset type 303,change operation type 304)*damp_f(level)+business_criticality
impact model 202 transforms the input into an impact value 306, in this example a numeric value is used.
damp_f takes into account the level or distance from the changed node and its value is lower for higher levels. It can be calculated for example as damp_f (level)=(1−level)*0.15 e.g., reducing the value by 15% for each level that it is further distanced from the change node).
business_criticality is used to elevate or lower the risk of the edge based on its importance (production environments should have higher risks in comparison to development environments).

Another mechanism could be based on historical data, where the edge risks were estimated based on the occurrence of different changes.

This data can be tuned in a machine learning model that would take as an input impact model 202 and some other features (level, business criticality . . . ) and predict known edge risk values.

Once propagation risk values for the edges are generated (208), Propagation trees 810 with edge impacts 209 are generated for each change. In an embodiment of the disclosure, all the propagation trees 810 with edge impacts 209 are merged into one with the use of functions for combined edge impact propagation 210. This is necessary since some edges 604 can appear in multiple propagation trees 810 and can have different edge risks. Optionally, the functions for combined edge impact propagation 210 can aggregate values, for example by taking the maximum value, median value or average value. Based on rules, some edges may be handled differently, depending on the edge type, change type, connectivity between different changed nodes. As an example, a connected edge between two changed nodes that are both of the operation type delete, may be disregarded.

Additionally, functions for merging propagation trees (210) into one can be tuned based on the historical data, where different propagation trees for different changes are used to predict a merged propagation tree or edge risks.

The output of the process to merge propagation trees with edge impacts (211) is one combined propagation tree with edge impacts 212.

For a single change (e.g., 701) the process to generate Propagation Risks for Edges 208 generates a single propagation tree with edge impacts 209. Therefore, the output of a process to merge propagation trees with edge impacts (211) just outputs the propagation tree with edge impacts 209 as the combined propagation tree with edge impacts 212.

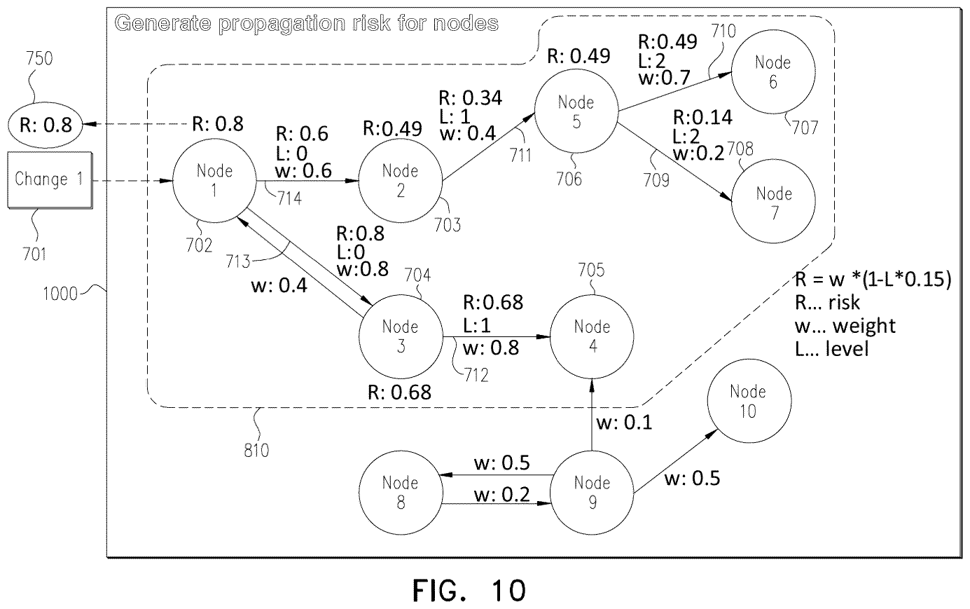

In an embodiment of the disclosure, after generating a combined propagation tree with edge impacts 212 the impact score generation module 102 generates propagation risks for nodes (213), for example as shown in FIG. 10. This process back propagates the edge risks to nodes 602, meaning that it starts with the outermost edges (edges 604 on the last level). Then, it propagates the risk (R) from these edges 604 to the source nodes 602 of these edges 604 according to the function (multiple edges 604 can share the same source node 602). The function can take the edge risks (R) of the same source node 602 and aggregate them into one value by using aggregation functions such as maximum, median, average or by using rules (some edges based on their dependency type or source/destination asset type might be more important than others, which should contribute more to the aggregated value). Once the source nodes 602 of the edges 604 on the last level have risks (R), a similar calculation is done for the next/previous level, except that the source nodes risk values (R) are calculated with the edge risks (R) connecting source nodes and their destination nodes and their destination node risks (these are risks that have been calculated in the first step). This is iteratively done until the changed nodes have been reached and a final risk value 750 (see FIG. 10) is determined.

The function for aggregating edge risks (R) to nodes can also be based on historical data, where the node risks (R) for different changes have already been estimated and the model that takes into account edge risks (R) and some other features, such as level, business criticality, topology, change parameters, number of siblings in a tree, can be tuned.

The output of the process Generate propagation risks for nodes (213) is a dependency graph with risks 214.

The dependency graph with risks 214 can also be post processed. Some nodes or edges can be pruned if their risks are below or above a certain threshold, if the value of risks does not change in comparison with the previous level.

### Output

In an embodiment of the disclosure, the process of impact score generation (200) generates a dependency graph with risks 214 for specific changes 203. Each changed node has a corresponding impact risk 750. The impact model 202 can generate impact values 306 depending on the impact category 305, which indicates that multiple risk values 750 of changed nodes can be generated based on the impact category 305 used in the impact model 202. In an exemplary embodiment, in output 400 the following impact categories 305 are used to calculate the risk 750 of changed nodes 405: performance 401, availability 402, security 403, and others 404. The changed nodes 405 have a risk value for each calculated impact category 305, performance 406, availability 407, security 408 and others.

All risks 750 per each impact category 305 can be combined into one value using a combined risk generator module 409. This can be done in many different ways, such as using (weighted) average risks, multiplying the risks, using expert rules to combine the risks, using a minimum or a maximum method, using machine learning models (where historical data is used to predict overall risk). The resulting value can represent the overall/total risk 410 of a changed node 405 or it can be further used in a “Set risk” generator 411 which takes combined risks for all changed nodes and combines them into an overall risk score 412. The overall risk score 412 represents the overall risk of a deployed set of changes 203. In Set risk generator 411 the change combined risks can be similarly combined into one using (weighted) average risks based on change properties, multiplying the risks, using expert rules to combine risks based on change properties, using minimum or maximum method, using machine learning (where historical data and changes properties are used to predict the overall risk score 412).

### Implementation Example

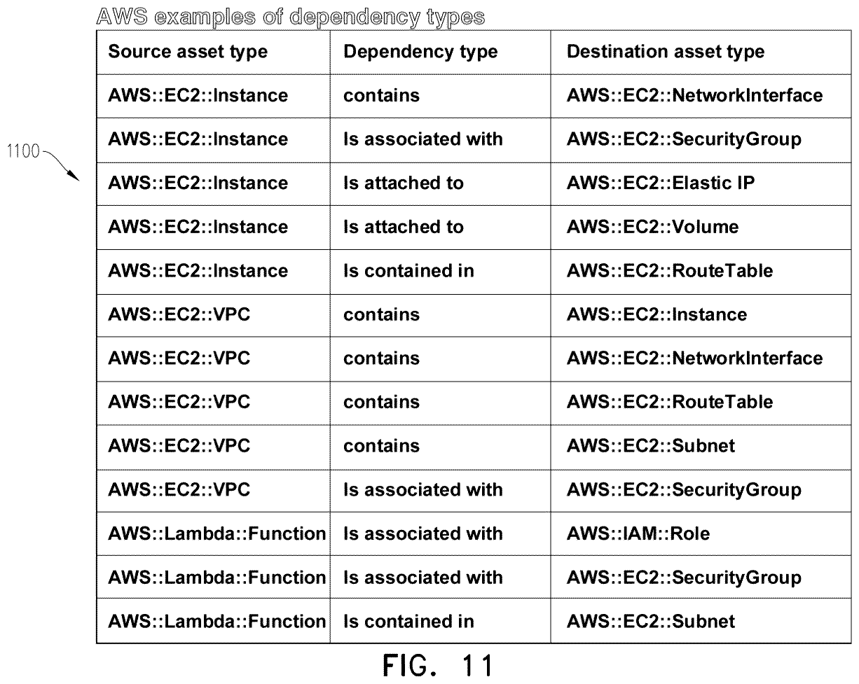

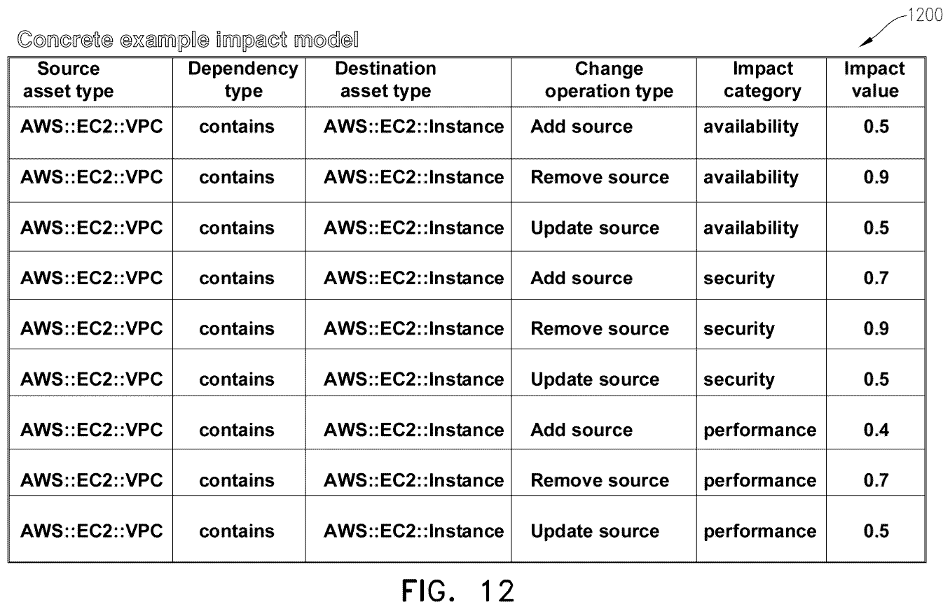

An example of the impact score generation process (200) is described as follows. A dependency graph 600 is constructed from an asset dependency table 505 or an asset graph 500. FIG. 11 provides additional examples 1100 of asset dependencies in an Amazon Web Service (AWS) environment. Asset dependency table 505 includes an asset source type 301, a dependency type 302 and an asset destination type 303, whereas dependency graph 600 contains instances of these types. In an embodiment of the disclosure, FIG. 12 provides a further example 1200 of an impact model 202 from an AWS environment for use in the impact score generation process (200).

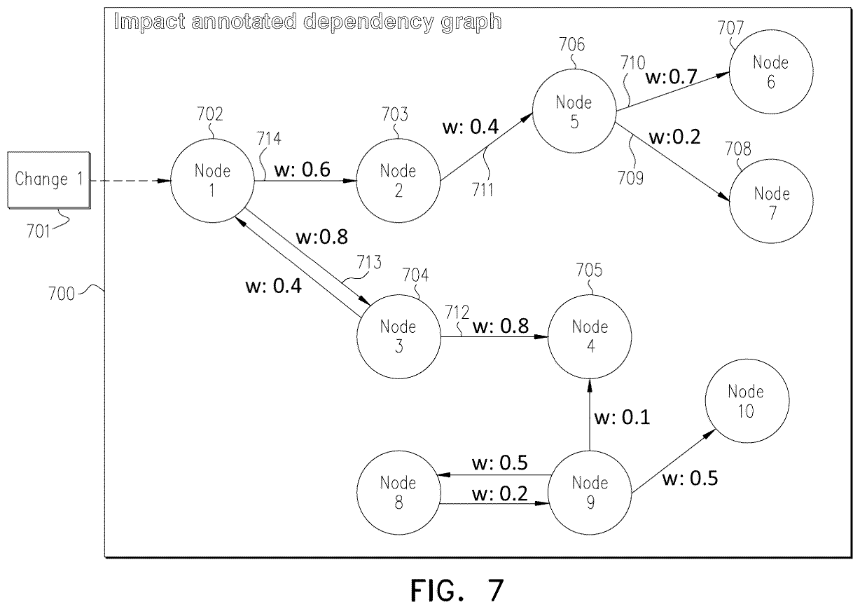

FIG. 7 exemplifies the first process of impact score generation process (200) to Annotate a dependency graph with impacts (204), which results in an Impact-annotated dependency graph (205, e.g., 700). First, change 1—701 is mapped to the corresponding node where the change happened e.g., Node 1—702. Each edge gets an initial impact from the impact model, which takes into account source node 301, dependency type 302, destination node 303, change 304, and impact category 305. The initial edge impacts are represented by “w”.

FIG. 8 exemplifies the next process of the impact score generation process (200) to Identify and generate a propagation tree (206), which results in a Propagation tree (207, e.g. 810). First, identification of all the nodes that Node 1—702 can impact: Node 2—703 and Node 3—704. In a similar way, all the nodes that Node 2—703 and Node 3—704 can impact, are identified, and all nodes that the identified nodes can impact are identified to form a propagation tree (207, e.g. 810), until no more nodes that can be impacted remain. In this way, the propagation tree (207, e.g. 810) consisting of nodes: Node 1—702, Node 2—703, Node 3—704, Node 4—705, Node 5—706, Node 6—707, and Node 7—708 is identified.

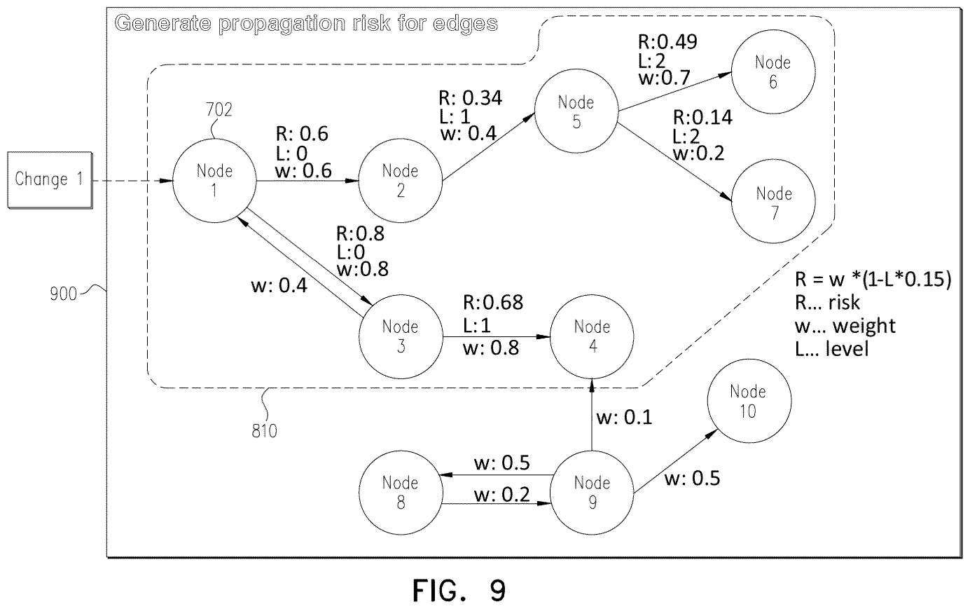

FIG. 9 exemplifies the next process to generate propagation risks for edges (208) as shown in diagram 900. In this example, the following formula for calculating edge risks is:

$$R = w * ( 1 - L * 0.15 ) ,$$

where
R . . . edge risk
w . . . initial impact
L . . . level (number of edges away from the initial node, Node 1—702).

The edges in the identified propagation tree 810 already have values for initial impact w and level L. Therefore, each edge gets its edge risk (R) based on the formula above to form a Propagation Tree with Edge Impacts (209).

FIG. 10 exemplifies the process of generating a propagation risk value for nodes (213) as shown in diagram 1000. For example, starting with edges on the level 2—709, 710 of propagation tree 810, the risks of 0.49 and 0.14 are combined to calculate the risk of Node 5—706. For combining the risk, the maximum function is used, therefore the risk for Node 5—706 is 0.49 (from edge 710). Next, in level 1, the risk for two nodes Node 2—703 and Node 3—704 need to be calculated. Node 2—703 aggregates as maximum the risk of edge 711 with a value of 0.34 and the risk of its impacted node that already has a calculated risk, Node 5—706 with a value of 0.49. Therefore, the risk of Node 2 is 0.49. Calculating the risk of Node 3 takes into account only the risk of edge—712 with a value of 0.68; therefore the risk of Node 3—704 is 0.68. For the last level, level 0, the risk of the Node 1—702 takes into account the risks of two edges—714 and 713 with values 0.6 and 0.8 respectively, as well as risks of impacted nodes, Node 2—703 and Node 3—704 with values 0.68 and 0.49 respectively. The maximum risk is therefore 0.8, which is applied to the initial, changed node Node 1—702. The calculated risk of a change 1—701 is therefore 0.8. This value can be mapped to different categories, such as low, moderate, or high risk.

### Examples of Usage

The system and method for impact propagation in IT systems (e.g., system 100) can uncover how the impacts of the changes propagate in the IT environment through dependencies between different components and can be used in the following ways: (a) incident analysis, (b) proactive use, (c) visualization tool.
a) Incident analysis: Once an incident happens, it is mapped to the corresponding node in the dependency graph (e.g. on which resource has the alarm or change occurred). Next, all nodes that might be responsible for the incident are filtered from the dependency graph and ranked according to their risk values—candidate nodes. The impact category for which the dependency graph is calculated can be based on the incident or change type/properties (e.g. for incident exposing credential issues the security impact category should be used).

Next, the candidate nodes are analyzed and filtered out based on the changes that occurred on the candidate nodes in relation to the incident. Most likely change(s) responsible to cause the incident can be reported back to the user(s). This helps with limiting investigation scope and automatization of root cause analysis.
b) Proactive use: the system and method for impact propagation can be used proactively in the following use cases: planning change, ticket approval process, in CI/CD (Continuous Integration, Continuous Development) pipeline, missing resource identification.
Planning a change involves assessing the impact of the potential change (that has not yet occurred) on the overall system. This can be used to avoid applying changes that are too risky in the system as a proactive measure.
ticket approval process: in issue tracking or project management tools, new changes are planned by specifying their requirements (for new features, for resolving issues and other issues) in the ticket. Once the work for the specific ticket has been completed, the system and method for impact propagation can be used to assess the risk of the changes corresponding to the ticket, and based on the score the option for approving a ticket can be enabled or disabled. This can also be a part of the CI/CD pipeline.
CI/CD pipeline: once the created changes are deployed into the CI/CD pipeline, the system and method for impact propagation can be used as one of the pipeline steps to estimate the risks of these changes and to either approve or reject the pipeline based on the change risks.
missing resource identification: the system and method for impact propagation can be extended in the following way. Based on rules defining which asset types should be connected (or the probabilities of that connections), missing resources can be identified and reported to users to create them.
c) Visualization tool: using a dependency graph with or without risks can help users to visualize the architectural overview of the whole system and the dependencies between the components. The dependency graph can be used to generate and persist an image to a permanent media such as file, to print it out, to attach it to the documentation.

In an embodiment of the disclosure, an application for evaluating impact propagation is stored on a non-transitory storage medium, such as a DVD, CD, external USB disk, disk-on key or other storage medium. The medium may be provided to a general-purpose computer to be executed to serve as computerized system 100 and provide the above described services.

It should be appreciated that the above-described methods and apparatus may be varied in many ways, including omitting or adding elements or steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure.

It will be appreciated by persons skilled in the art that the present invention is not limited to what has been particularly shown and described hereinabove. Rather the scope of the present invention is defined only by the claims, which follow.

1. A method of proactively evaluating impact of a planned change on nodes of a network, comprising:
collecting information of planned changes to configuration items of the network with a change management module that is executed on a computer of the network and forming a list of changes;
receiving a dependency graph that defines dependencies between nodes of the network,
receiving an impact model that includes an impact value that provides an indication of a risk value for different types of changes to nodes of the dependencies;
executing an impact score generation module configured to receive the dependency graph, the impact model and the list of changes to determine a risk value responsive to a specific change to a node of the network and an impact of the specific change on other nodes of the network;
predicting problems in the network based on the determined risk value for each planned change; and
responsive to said prediction selectively applying the planned change.

2. The method of claim 1, wherein the dependency graph represents the nodes of the network as nodes of the graph and the dependencies between the nodes of the network as directional edges connecting between the nodes of the graph.

3. The method of claim 1, wherein each entry of the impact model comprises: a source asset type, a destination asset type, a dependency type between the source asset type and the destination asset type, a change operation type, an impact category and an impact value.

4. The method of claim 3, wherein the impact score generation module annotates the edges in the dependency graph with impact values from the impact model.

5. The method of claim 4, wherein the impact score generation module identifies and generates a propagation tree that includes a changed node and nodes that are impacted by the changed node.

6. The method of claim 5, wherein the impact score generation module generates propagation risks for the edges of the propagation tree;
wherein the propagation risks are generated as a function of the impact values of the edges.

7. The method of claim 6, wherein the impact score generation module merges propagation trees to form a combined propagation risk for the edges.

8. The method of claim 7, wherein the impact score generation module generates a propagation risk for the nodes of the propagation tree as a function of the combined propagation risk of the edges;
wherein the propagation risk of the root node of the tree serves as the determined risk value.

9. The method of claim 3, wherein the dependency types include: “attached to”, “contained in”, “contains”, “impacts”, “depends on” and “associated with”.

10. The method of claim 3, wherein the impact categories include: “performance”, “availability”, “security”, “end user”, “capacity”, “financial”, “scalability”, “compliance”, and “integration”.

11. A computer system for proactively evaluating the impact of a planned change on nodes of a network, comprising:
one or more computers comprising:
a change management module that is configured to collect information of planned changes to configuration items of the network and forms a list of changes;
an impact score generation module configured to receive a dependency graph that defines dependencies between nodes of the network, a list of changes, an impact model that includes an impact value to provide an indication of a risk value for different types of changes to nodes of the dependencies;
wherein the impact score generation module is configured to determine a risk value responsive to a specific change to a node of the network and an impact of the specific change on other nodes of the network;
predicting problems in the network based on the determined risk value for each planned change; and
responsive to said prediction selectively applying the planned change.

12. The system of claim 11, wherein the dependency graph represents the nodes of the network as nodes of the graph and the dependencies between the nodes of the network as directional edges connecting between the nodes of the graph.

13. The system of claim 11, wherein each entry of the impact model comprises: a source asset type, a destination asset type, a dependency type between the source asset type and the destination asset type, a change operation type, an impact category and an impact value.

14. The system of claim 13, wherein the impact score generation module annotates the edges in the dependency graph with impact values from the impact model.

15. The system of claim 14, wherein the impact score generation module identifies and generates a propagation tree that includes a changed node and nodes that are impacted by the changed node.

16. The system of claim 15, wherein the impact score generation module generates propagation risks for the edges of the propagation tree;
wherein the propagation risks are generated as a function of the impact values of the edges.

17. The system of claim 16, wherein the impact score generation module merges propagation trees to form a combined propagation risk for the edges.

18. The system of claim 17, wherein the impact score generation module generates a propagation risk for the nodes of the propagation tree as a function of the combined propagation risk of the edges;
wherein the propagation risk of the root node of the tree serves as the determined risk value.

19. The system of claim 13, wherein the dependency types include: “attached to”, “contained in”, “contains”, “impacts”, “depends on” and “associated with”.

20. A non-transitory computer readable medium comprising an executable program configured to perform the method of claim 1.
